(19) United States
(12) Patent Application Publication
(10) Pub. No.: US 2005/0159840 A1
(43) Pub. Date: Jul. 21, 2005

(54) System for surface finishing a workpiece

(76) Inventors: Wen-Jong Lin, Singapore (SG); Xiao Qi Chen, Singapore (SG); Zhiming Gong, Singapore (SG)

Correspondence Address: CHRISTIE, PARKER & HALE, LLP, PO BOX 7068, PASADENA, CA, 91109-7068, US

(21) Appl. No.: 10/758,949

(22) Filed: Jan. 16, 2004

(51) Int. Cl. G06F 19/00

(52) U.S. Cl. 700/245

(57) ABSTRACT

A system is provided for finishing a surface of a workpiece, for instance by abrading a brazed area or welded area to remove excess brazed or weld material during the refurbishment of the turbine blade. A real-time control system has a controlled material removal rate strategy where a computer controls the different contact or polishing forces in real-time to achieve high accuracy.

### FIELD OF THE INVENTION

The invention relates to an apparatus and method for finishing a surface of a workpiece, and more particularly to a system to control an industrial robot and a precision module for finishing the surface of a workpiece.

### BACKGROUND

In finishing surfaces of workpieces having synthetic or free-form curves, such as, for example, car bodies, ship hulls, aeroplane wings, propeller blades or turbine blades, precision rendering is required. In the case of the refurbishment of used turbine blades, the process of refurbishing may be more complex than the process for manufacturing a new turbine blade. The complexity rises due to the distortion of a used turbine blade resulting from wear and tear. Specifically, the contour and angle of the used turbine blades are typically distorted relative to those of a new blade after operating in a high-temperature and high-pressure environment. Additionally, each used turbine blade is unique and different from all other used turbine blades.

Typical damage to a turbine blade includes damage to the turbine tip, such as cracks and chips, and such damage may be refurbishable or repairable. The damaged portion of the turbine tip is typically cut out, and a new material or braze material, for example Inconel materials, super alloys, cobalt, chromium, nickel, etc., or combinations thereof, is welded along the turbine tip to fill the gap formed by the cutting out of the damaged portion. As long as the used turbine blade meets certain requirements within specific agreed limits, such as uniformity of the blade pitch or that cracks do not extend into the toe of the blade, the used turbine blade may be refurbished in this way. Since the braze material is typically difficult to machine sand, belt blending is usually the preferred and most common process for turbine blade overhaul. The braze area of braze material is finished by a process such as sanding, cutting or the like to become flush with the original surface.

The refurbished turbine blade is traditionally finished by hand. To meet requirements and guidelines, a refurbished turbine blade typically has to be formed within a tolerance of 30 μm (microns). This is obtainable from a high skilled worker or teams of workers. Each worker usually requires a considerable period of training before becoming skilled in the process and the success of the refurbishment depends entirely on the high skill of the manual operator. Additionally, such a workspace where this operation is conducted is considered a health hazard-working environment, since many fine particles and powder are created during the finishing processes, such as the grinding process, which may be harmful to a worker's health. To avoid a health-hazard working environment, a robot may be used to perform the job of refurbishing.

For workpieces having synthetic or free-form curves, analytical curves are not sufficient to meet the geometry design requirements mathematically. The problem with using a low precision robot is meeting in the 30 μm (microns) tolerance requirement of mathematically curve-fitting to the desired surface of the workpiece, and in particular constructing smooth curves and surfaces on the workpiece. The position precision of a low precision robot, such as a legacy 6-axis robot, is measured in multiples of 0.1 mm. Therefore the use of such low precision robots does not meet the 30 μm (microns) tolerance requirements. Using high precision robots (with an accuracy <30 μm (microns)), the 30 μm (microns) tolerance requirement can be met. However, the cost of a high precision robot is usually high. To achieve the desired finishing profile and surfaces, the contact force and the compliance between the tool and blade must be maintained, since the surface of the turbine blade with braze material is irregular after brazing.

For example, U.S. Pat. No. 4,894,597, issued on 16 Jan. 1990 to Ohtomi, describes a deburring robot. A laser beam sensor is mounted on the grip of the robot, to which grip the grinder is also mounted. The robot is moved relative to a stationery workpiece. The laser beam sensor radiates the workpiece with a laser beam to detect the difference in distance between the laser beam sensor and the workpiece relative to the grinder. However, the accuracy of the robotic system is hampered since the robotic system accumulates all position errors from the structure of the robot and the sensor, which prevents a high accuracy or an error, or fault tolerance within 30 μm (microns). Hence, the robotic system described in U.S. Pat. No. 4,894,597 is not of compensating for a grinding error due to wear and tear on the grinding wheel.

U.S. Pat. No. 5,241,792, issued on 7 Sep. 1993 to Naka et al., describes a method and apparatus for surface furnishing, where the robot applies a substantially constant polishing force. This uses a fluid actuator during the finishing process to compensate the wear and tear of the polishing tool. The system of U.S. Pat. No. 5,241,792 is not capable of compensating for the discrepancies in the surface of a workpiece due to wear and tear since response time of the fluid actuator is far below an electrical actuator, such that the fault tolerance of 30 μm (microns) is not achievable.

A robotic system developed by Singapore Institute of Manufacturing Technology, includes two polishing machines so that the automation system can continue a blending process uninterruptedly when one polishing machine is not in use, for example when a worn-out abrasive belt is being replaced. The system uses a linear variable differential transducer (LVDT) contact probe to measure ten points on the surface of a turbine vane, and performs a profile fitting with design data to generate the actual robot path. During polishing, the system tries to maintain a constant contact force between the workpiece and the polishing machine, while the control approach is a passive contact force control employing a stiff spring. However, the control system does not actively control the contact force so that the grinding accuracy fully depends on the accuracy of the robot.

A robotic grinding system developed by ZENON has a 6-axis robot, a coordinate measurement machine (CMM), a belt grinding machine, and a host controller. The system uses the CMM machine to measure the used blade before grinding, without any in-situ measurement method. The system utilizes a process to simulate a manual operation, that is a belt grinding machine, with the addition of a robotic arm holding the blade, and a motion mechanism to maintain the contact force between the workpiece and the tool at a constant level. However, the system does not apply different contact forces at different grinding points with different thickness of excessive braze material.

Therefore, a need exists for a system that integrates a lower precision industrial robot to achieve higher accuracy than that of the specification of the industrial robot. There is another need, for improving the efficiency and the cycle time of finishing surfaces of workpieces, such as in the refurbishment of used turbine blades with the use of a robot. Another need exists to remove manual workers from exposure of health-hazardous working environments by replacing manual workers with robots, and yet achieving the same or better quality of finished workpieces that have synthetic or free-form curves. Another need exists to reduce the cycle time and to minimize the time taken by co-ordinate measuring machines (CMM) to finish surfaces of workpieces, such as in the repair of turbine compressor blades to reuse them instead of discarding and replacing them with new components.

### SUMMARY

According to an aspect of the invention there is provided a system for treating a workpiece. The system comprises: a robot having a holder, a treatment device, a contact force measurement device, a position measurement device and a controller. The holder holds the workpiece and traversing the workpiece along a predetermined path. The treatment device performs a treatment on the workpiece, the treatment device having a treatment tool for contacting the workpiece at at least one point along the path. The contact force measurement device provides information on the actual contact force between the treatment tool and the workpiece. The position measurement device provides information on the actual position of the treatment tool. The controller is in communication with the robot and the treatment device and controls the system in accordance with predetermined position data and predetermined contact force data, based on the predetermined path of the workpiece. The controller is responsive to the actual contact force information and the actual position information, the controller receiving the actual contact force information from the contact force measurement device and the actual position information from the position measurement device.

According to another aspect of the invention there is provided a method of treating a workpiece. The method comprises: holding and traversing the workpiece along a predetermined path; performing a treatment on the workpiece by way of a treatment tool at at least one point along the path; determining the actual contact force between the treatment tool and the workpiece; determining the actual position of the treatment tool; and controlling the system. The system is controlled in accordance with predetermined position data and predetermined contact force data, based on the predetermined path of the workpiece, in response to the determined actual contact force and the determined actual position information.

According to again another aspect of the invention there is provided a workpiece which has been treated according to the above method.

### BRIEF DESCRIPTION OF THE DRAWINGS

These and other features, objects, and advantages of embodiments of the invention will be better understood and readily apparent to one of ordinary skill in the art from the following description, in conjunction with the drawings, in which:

FIG. 1 is a schematic diagram of a system in accordance with an embodiment of the invention;

FIG. 2 is a block diagram of a control system in accordance with an embodiment of the invention;

FIG. 3 is a graph of data sensed by a laser scanner from a workpiece in accordance with an embodiment of the invention;

FIG. 4 is another view of a laser sensor and laser path incident on a workpiece in accordance with an embodiment of the invention;

FIG. 5 is a front elevational view of a robot and finishing device with coordinate frames in accordance with an embodiment of the invention;

FIG. 6 is a graph of finishing path generation in accordance with an embodiment of the invention;

FIG. 7 is a schematic diagram of the robot gripper holding tool in accordance with an embodiment of the invention; and

FIG. 8 is a schematic diagram of an adaptive tool head of the finishing device in accordance with an embodiment of the invention.

### DETAILED DESCRIPTION

A system is provided for finishing a surface of a workpiece, for instance by abrading a brazed area or welded area to remove excess brazed or weld material during the refurbishment of the turbine blade. A real-time control system has a controlled material removal rate strategy where a computer controls the different contact or polishing forces in real-time to achieve high accuracy.

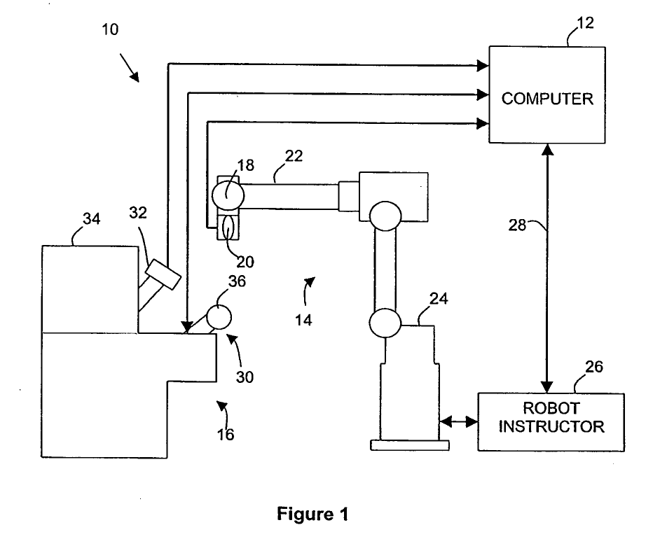

FIG. 1 shows a treating system 10 having a precision motion mechanism for surface treating a workpiece, usually to finish it or to treat its finish, in accordance with an embodiment of the invention. The system 10 includes a computer 12, a robot 14 and a machining apparatus 16.

The robot 14 has an end-effector holding tool, such as a gripper or holder 18, which, in use, holds a workpiece 20. The end-effector holding tool 18 is mounted at the end of a robot arm 22, which arm 22 is movably and controllably mounted relative to a robot base 24, to traverse the workpiece along a predetermined path. The computer 12 is in communication with and controls the robot 14 by a robot instructor 26. A communication link 28 between the computer 12 and the robot instructor 26 may be a serial link such as RS232, a bus or the like. The end-effector holding tool 18 includes a sensor, such as a contact force sensor, which feeds data back to the computer 12.

The machining apparatus 16 has a treatment device 30, in-situ measurement equipment 32 and a machine apparatus body 34. The treatment device in this embodiment is a finishing device 30 and includes a treatment tool, which in this embodiment is a finishing tool 36, one or more sensory elements or devices, for instance position and force sensors and a micro-position control system with a decoupling mechanism. The measurement equipment 32 also includes one or more sensory elements or devices, for instance a distance sensor for profile scanning. The finishing device 30 feeds back data to the computer 12, such as micro-position feedback and control signals from the micro-position control system. The measurement equipment 32 also feeds back data to the computer 12, such as grinding result feedback signals from the one or more sensory elements or devices. The computer 12 communicates with and controls the finishing device 30.

The robot 14 may be a lower precision robot, for example a legacy 6-axis robot having a precision position that is measured in multiples of 0.1 mm. An example of such a robot is the FANUC™ robot S-10, manufactured by FANUC Robotics America, Inc., of Rochester Hills, Mich., USA. The embodied system 10 provides finer precision than the capabilities of the robot alone, to enable the lower precision robot to be used in finer precision applications, for example 30 μm (microns) fault tolerance, as may be required in the refurbishment of particular workpieces 20, such as turbine blades. However, it will be appreciated that the embodied system 10 may be implemented on higher precision machines as well. In this embodiment, the workpiece 20 to be worked on is a turbine blade, but the system may be used with other types of workpieces. The robot 14 holds the turbine blade 20 with the holder 18 to execute a blending motion route program, under computer control via the robot instructor 26.

The precision motion mechanism of the treating system 10 includes the sensory elements or devices within the robot end-effector holding tool 18, the finishing device 30 and the in-situ measurement equipment 32. The system 10 is able to achieve accuracy that may exceed the accuracy of the robot 14.

The computer 12, for example a personal computer or a more dedicated computer may have an I/O interface (not shown) to communicate with the various components and devices, a central processing unit (not shown) and a memory (not shown), such as a read only memory (ROM) and/or a random access memory (RAM). The CPU and memories allow such a computer 12 to process information such as a computer software program embodying a method of controlling the elements, such as the robot 14 and the sensors in the finishing process. The communication between various elements of the system 10 may be by wire or wireless means or the like. Aspects of the invention may be implemented as software or a computer program. For example, the software or computer program may be stored or recorded on a computer readable medium to provide a computer program product.

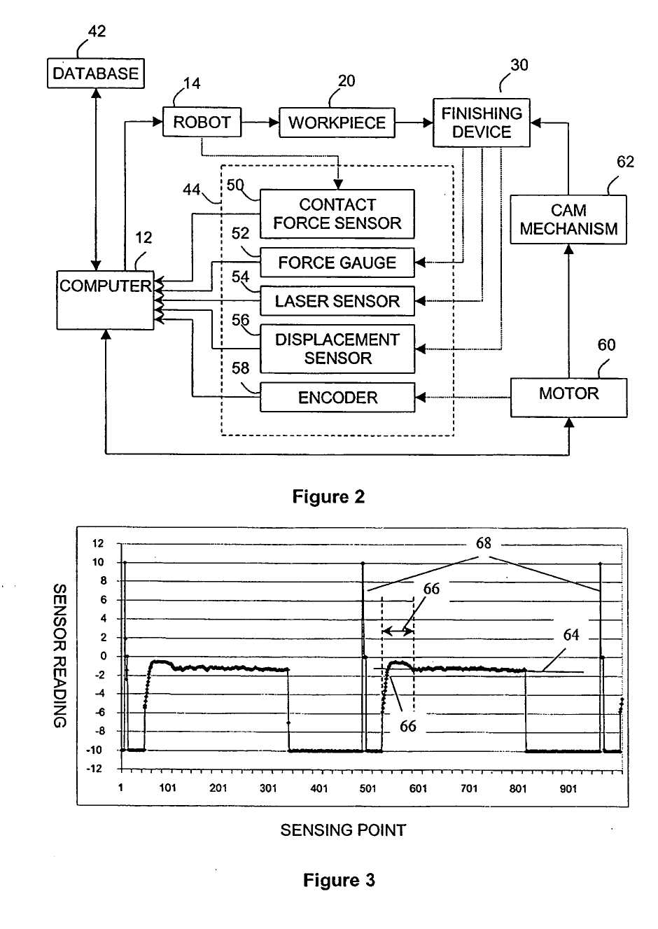

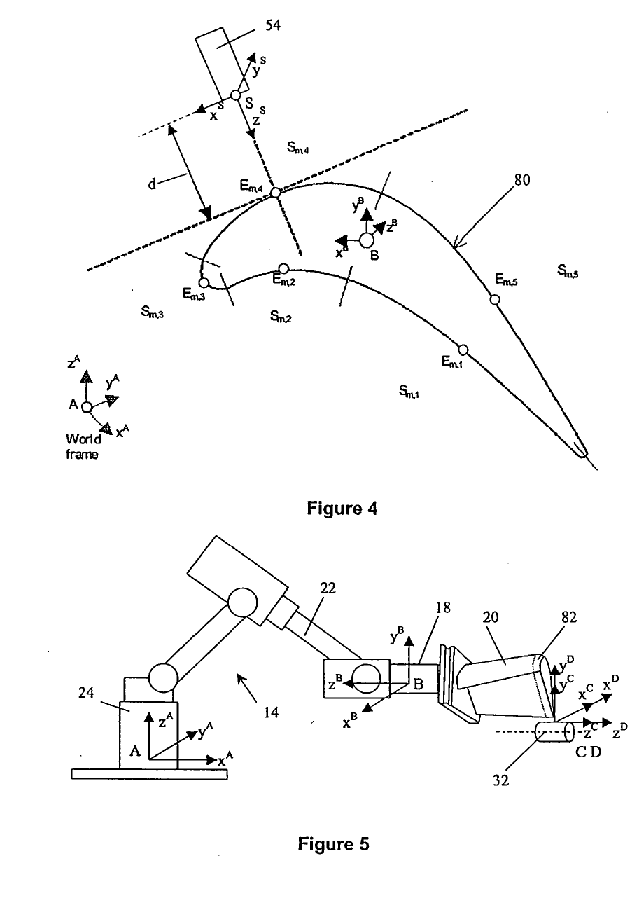

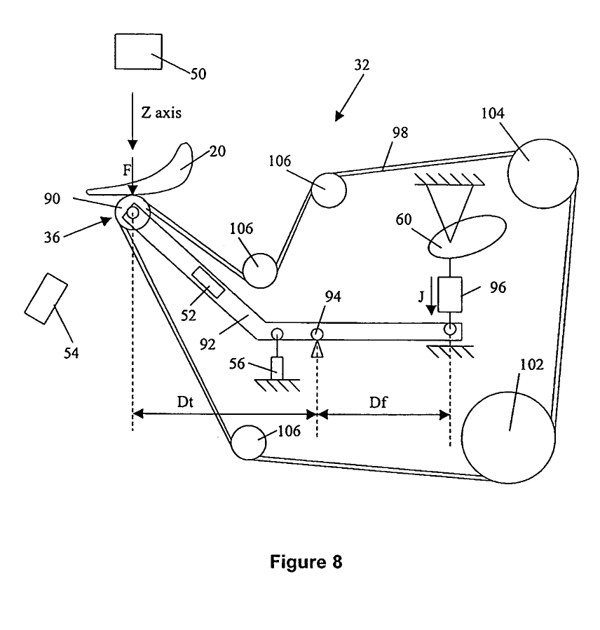

FIG. 2 depicts a block diagram of a control system 40 of the treating system 10. The control system 40 is operated by the computer 12, based on data about the desired workpiece shape and blending process knowledge such as predetermined position data and predetermined contact force data (for instance stored on an external device such as a database 42) and data from the various sensors and measurement devices 44 (stored on internal memory during use). The various sensors and measurement devices 44 include: a contact force sensor 50, between the robot end-effector holding tool 18 and the robot arm 22, for sensing a force or moment, and shown in more detail in FIG. 7; a force gauge 52 on an arm of the finishing device 30 and shown in more detail in FIG. 8; a profile sensor 54 in the in-situ measurement equipment 32 and shown in more detail in FIG. 4; a displacement sensor 56 (contact or non-contact) also in the finishing device 30 and shown in more detail in FIG. 8; and an encoder 58 attached to an end of a motor 60, which may be a digital servo motor, and used to feedback a motor rotation angle. The contact force sensor 50 and the force gauge 52 together form a contact force measurement device for providing actual contact force information of the contact force between the finishing tool 36 and the workpiece. The force gauge 52 and the displacement sensor 56 of the finishing device 30 together form a position measurement device which is for providing actual position information of the finishing tool 36.

The dotted lines from the finishing device 30 to various of the sensors and measurement devices 44 indicate that movement of the finishing device 30 can directly affect those specific sensors and measurement devices 44. Likewise the dotted line from the robot 14 to the force sensor 50 indicates that movement of the robot 14 can directly affect the force sensor 50 and the dotted line from the motor 60 to the encoder 58 indicates that movement of the motor 60 directly affects the encoder 58.

The computer receives and processes sensed data from the various sensors and measurement devices 44, with the other downloaded data and data in the database 42 for optimal workpiece treatment such as profile fitting, path planning, position/force control, and maintaining the knowledge database 42. The computer 12 is programmed to control the motor 60 to rotate it by desired angles, which, in turn turns a drive cam mechanism 62 to adjust the finishing tool position of the finishing device 30. The programmed computer 12 also downloads a calculated motion program to the robot 14. The purpose of the computer is therefore as a controller of the finishing device 30 as well as to input data to control the robot instructor 26.

Position and force data are monitored and taken from the components or elements of the various sensors and measurement devices 44 and fed back to the computer 12. For example, profile sensing data is fed back from the profile sensor 54 to the computer 12. Micro-position data of the finishing device 30 is fed back from the displacement contact probe 56 to the computer 12. Rotation feedback data is fed back from the encoder 58 to the computer 12. Similarly, force/moment data is fed back from the force sensor 50, to the computer 12. Force data and micro-position of the finishing device data is fed back from the force gauge 52, which may be based on the strain-stress principle, and the displacement contact probe 56, respectively, both located on the finishing tool 30, to the computer 12. Based on the data received at the computer 12 from the various sensors and measurement devices 44, the computer 12 controls the robot 14 via the robot instructor 26, and the motor 60 of the drive cam servo-motor of the cam mechanism 62 on the finishing device 30. The computer 12 downloads a determined motion program for a blending path of the robot end-effector holding tool 18 to follow in a blending sweep, based on the in-situ measurements to the robot instructor 26 to operate and control the robot 14. The workpiece 20 is machined in the controlled manner accordingly. The in-situ measurement provides on line data to the computer 12 for the next blending path in the next sweep of the workpiece on the finishing device 30. The various sensors and measurement devices 44 collect all the data after the blending process and feed the data back to the computer 12 to generate the contact force data for the path of the decoupling mechanism in the next blending sweep.

The predetermined position data is used to control the robot 14, and the predetermined contact force data is used to control the decoupling mechanism. The treating system 10 is used on a brazed or welded area to remove excess braze or weld material during the refurbishment of the turbine blade. The real-time control system has a controlled material removal rate strategy, where the computer 12 controls the different contact or polishing forces from the decoupling mechanism in real-time to achieve higher accuracy than the limited accuracy of the robot 14. The quality requirements of turbine blade blending in this embodiment include a tolerance of less than 30 μm (microns) for overcutting, less than 30 μm (microns) for undercutting, no overcutting of the trailing edge, within ±30 μm (microns) from the parent body having a smooth curvature, a wall thickness of greater than a minimum wall thickness of 0.762 mm, a surface roughness of less than 11.6 μm (microns) Ra, and no visible transition lines from brazed to non-brazed areas.

The space curve that the robot end-effector holding tool 18 moves along from the initial location (position and orientation) to the final location in each sweep is referred to as its path. The path describes the desired robot end-effector motion as a sequence of points in space (position and orientation of the robot end-effector holding tool 18) through which it is desired that the robot end-effector holding tool 18 should pass, as well as the space curve that the end-effector holding tool 18 traverses. Points on the path are generated in one set of coordinates, for example Cartesian coordinates, rather than another set of coordinates, for example joint coordinates, for easier visualization. Using Euler angle computation and coordinate system transformation, the robot end-effector location (position and orientation) in global Cartesian coordinates may be computed from the local coordinates of blending points in the robot end-effector's coordinate system. Each path knot point for the robot end-effector holding tool 18 is described by six robot coordinates, for example (X,Y,Z,w,p,r), where coordinates (X,Y,Z) specify the robot end-effector position while coordinates (w,p,r) specify the robot end-effector orientation. For the space curve between any two points, the robot automatically moves using, for example, the cubic spline motion. Thus, the robot coordinates (X,Y,Z,w,p,r) of the points which the robot end-effector is to traverse, in the global Cartesian coordinate system, are derived.

The finishing process is typically a blending process, which is a material removal process to achieve a desired finishing profile with a required finishing surface roughness, for applications such as removal of the excess materials on surfaces of new jet engine parts or the overhaul of turbine blades. The blending process includes rough grinding as a step to remove the bulk of the excess material, with profile generation as the primary aim, and fine polishing as a step to achieve the desired surface roughness. It will be appreciated that blending is interchangeable with grinding, polishing, or other similar workpiece treatments.

Before the finishing process, the profile sensor 54 is used to scan the surface of the turbine blade 20. The computer 12 uses the scanned data to conduct optimal profile fitting, to reconstruct the prior-to braze tip profile and to generate the robot finishing path. During finishing, the profile sensor 54 in-situ detects the thickness of excess braze material at a current blending point and the computer 12 determines the respective required or desired contact force in accordance with data from the blending process knowledge database 42 and data of the turbine blade profile data. The data of the turbine blade profile is used to provide the commands to control the robot following a predefined motion path. Data from the database 42 may be data of the controlled material removal rate, to provide a relationship between the thrust force (Newtons) and material removal rate (mm³/S).

Both the force sensor 50 at the end-effector holding tool 18 of the robot 14 and the force gauge 52, at the finishing device 30, collaboratively provide force feedback of the actual contact force exerted between the workpiece 20 and the finishing tool 36 at the end of the blending device 30. The displacement contact probe 56 is used to measure the position of the finishing tool 36. With the desired and actual data of the contact force and the blending wheel position, the computer 12 controls the motor 60 to drive the cam 62 forward or backward, as required, to maintain the desired force and compliance at the current blending point between the workpiece 20 and the finishing tool 36.

For the profile sensor 54 for profile scanning of the workpiece 20, the sensor may be a contact or non-contact sensor. For example the profile sensor 54 may be a linear variable differential transducer (LVDT) or a coordinate measuring machine (CMM), with a contact probe for contact applications. For non-contact applications, an optical sensor may be used to measure the three dimensional profile of the workpiece 20. With optical sensors, for some workpieces 20 with shiny surfaces such as turbine blades, the shiny surface may disturb the scan using a laser beam. By controlling the laser beam incidence direction, such that the laser incidence direction is near the normal direction at the scanning point of the object surface, the scanning quality is maintained. In the preferred embodiment, the profile sensor 54 is a laser sensor 54.

FIG. 3 is a graph of the laser scanning sensing data for the turbine blade 20, for use in reconstructing the profile data. Significant portions of the graph include the turbine blade slope 64 on the parent materials, the welded turbine blade tip height (H) 66, the scanning start pulse 68 and the turbine blade tip or the leading edge of the workpiece 20.

The welded turbine blade tip height H is the distance from the turbine blade tip to the turbine blade parent body. The turbine blade tip height H is a parameter that is controlled and maintained during the blending process, such that the height H meets strict requirements, for example that the tip height H is no more than 30 μm (microns) along the blade tip. The laser sensor 54 monitors the tip height H in real time during the blending process.

FIG. 4 shows the laser sensor 54 for sensing and monitoring a turbine blade profile 80. The laser sensor 54 has a laser sensor coordinate system S, and the profile data of the turbine blade 20 has a workpiece natural coordinate system or robot end-effector coordinate system B. A world flame coordinate system A is used as a reference coordinate system.

Reconstruction of the turbine blade tip profile data prior to brazing involves, for example, a non-contact mode with the laser sensor 54. For this embodiment, a turbine blade profile template is used and its tip divided into a number of reference layers for scanning. Each reference layer m is divided into five profile portions S_{m,n} (1≦n≦5), as shown in FIG. 4. The profile portions with smaller curvature ratios have larger curve lengths, so that each profile portion can be scanned with the same number of data points. For each profile portion the laser sensor 54 is positioned in a direction that is normal to the curve at a central point E_{m,n} (1≦n≦5) (along the length of the profile portion) of the respective profile portion, to monitor the profile portion and to record the coordinates of the points of each profile portion with respect to the sensor coordinate system S. The points of each profile portion are then transformed from the sensor coordinate system S into the workpiece natural coordinate system B. With certain orders, such as a 15^{th} order of polynomial interpolation, a collection of analytical formulae is generated to approximate the layer of profile data, within a tolerated error allowance. This procedure is done for each layer m, for any number of layers at the tip of the blade. Each layer is a different distance from the root plane portion of the turbine blade. The information derived from the scans is stored in the database 42.

Other ways of reconstructing the turbine blade tip profile may be envisaged, including using contact or other non-contact applications. Different profile reconstruction techniques may be employed, for example after the profiles have been sensed and calculated in the robot end-effector frame B, each layer profile can be divided into N (e.g. N=1000) sections respectively by N points. To reconstruct the blade tip layer prior to braze the profile, methods may be employed such as the “Method for Determining Shape Data” as described in a U.S. patent application Ser. No. 10/715,877 filed by the same applicants on 17 Nov. 2003 and incorporated herein by reference.

FIG. 5 shows the robot 14 with the robot end-effector holding tool 18, holding the workpiece 20 in relation to the finishing tool 36, in operation, for finishing the edge or tip 82 of the workpiece. The path that the robot end-effector holding tool 18 moves along from its initial location to its final location is discussed earlier. Each path knot point of the robot end-effector holding tool 18 is described by the six robot coordinates (X,Y,Z,w,p,r). A 13×3 rotation matrix is defined as a transformation matrix to describe and represent the rotational operations of the robot end-effector coordinate system with respect to the global coordinate system, which is established at the base 24 of the robot 14 as the reference coordinate frame.

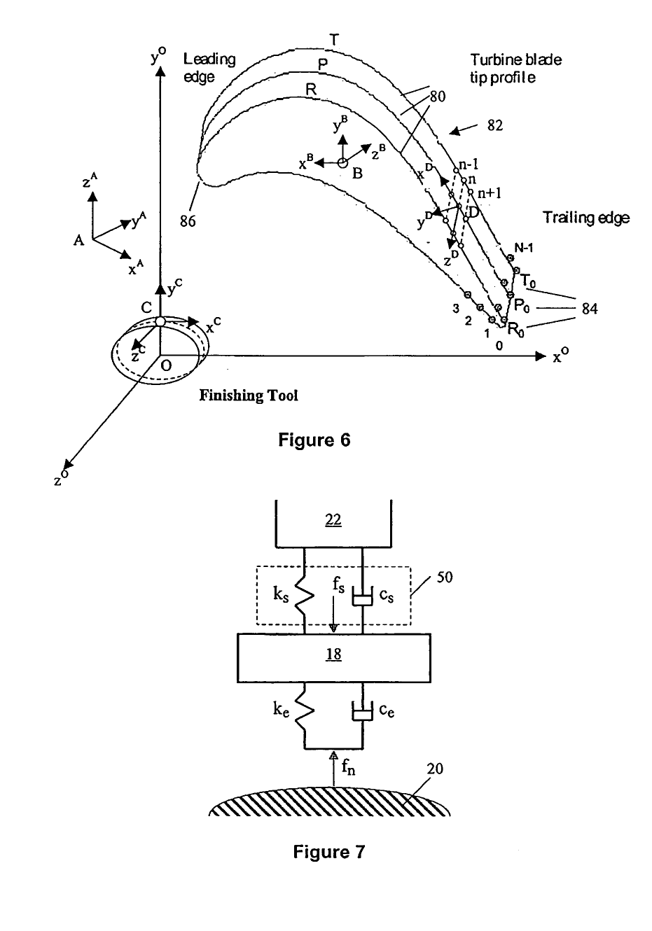

The blending or robot path, that is the sequence of points the robot end-effector holding tool 18 follows to blend the surface of the workpiece, described in terms of robot coordinates (X,Y,Z,w,p,r) as set forth above, is recognized by the robot instructor 26. FIG. 6 shows three layers of a turbine blade tip profile 80. Using the three dimensional profile data of the turbine blade provided by online profiling, assuming the depth of the tip 82 is comparatively small, for example 5 mm, the turbine blade tip profile is divided into only three layers, a central layer P and two neighboring layers R and T. N points along the profile of each layer divide each layer into N sections, starting from the trailing edge (tail) 84 of the blade to the leading edge (head) 86 of the blade. To achieve a smooth blending path, the number of points chosen is quite large, for example N=1000. For blending, a part coordinate system D is created for each point. The part coordinate system D has its origin at the n^{th} point of layer P, that is point Pₙ, with the x axis lying in the direction from point Pₙ to point Pₙ₋₁, the z axis lying in the direction from point Pₙ to point Rₙ and the y axis lying in the normal direction of the blade surface at point Pₙ and pointing inwards.

The tool coordinate system C is formed at the finishing tool 36, and has an origin at the contact point on the surface of the finishing tool 36, the z axis lying in the axis direction of the finishing tool 36, the y axis lying in the direction of the global z axis and the x axis formed by the rule of the right-handed coordinate system. The tool coordinate system C is known with reference to the global coordinate system A once the blending machine is installed.

During a blending process, the workpiece 20 is held at the desired blending position, where the two coordinate systems C and D are coincident with each other. Based on this, the position of the robot end-effector's coordinate system B is determined by a co-ordinated system homogeneous transformation and the robot coordinates (X,Y,Z,w,p,r).

Computing the robot coordinates (X,Y,Z,w,p,r) of a blending point involves five steps:

1) compute the blending points in robot end-effector coordinate system B;

2) construct a part coordinate system D for a blending point;

3) based on the part coordinate system D being coincident with the tool coordinate system C when blending, compute the position and orientation of the robot end-effector coordinate system B, with reference to global coordinate system A, using the coordinate system homogeneous transformation;

4) from the position and orientation of the robot end-effector in the global coordinate system A, derive the robot coordinates (X,Y,Z,w,p,r); and

5) repeat steps 12) to 14) to obtain a series of the robot coordinates (X,Y,Z,w,p,r).

With the above steps, a series of robot coordinates (X,Y,Z,w,p,r) is developed for desired blending positions, which form the robot blending path.

For removing material in an automatic system and making the brazed area flush with the rest of the workpiece surface, the process parameters involved may differ for different workpieces such as in different used turbine blades. Some process parameters include: grit size, type of grit bonding, tension of an abrasive belt; wheel material, diameter, construction, stiffness, hardness, and contact angle of the wheel; contact wheel deformation; belt speed, vibration, and wear; tool head vibration; approach angle; feed rate; contact force; and removal rate. Among the process parameters, the contact force is the prime factor to consider for removal of excess braze material. In a traditional machining process, the contact force is kept at a constant level regardless of the different blending conditions at the particular blending point, for example, regardless of the thickness of excess braze material, profile curvature, etc. In the system 10 of the present embodiment, the contact force exerted on the workpiece 20 changes at different blending points in consideration of the current blending conditions or process parameters at any particular time during the process. For example, a greater controlled contact force is exerted on a blending point with a sensed thickness of excess braze material that is larger than normal, whereas a smaller controlled contact force is applied to a blending point with a sensed thickness of excess braze material that is less than normal. Relevant information may be provided by a look-up table in the database 42, with information such as the optimum contact force versus thickness of excess braze material or profile curvature. Accordingly, material removal rate is increased and production is more efficient over traditional machining without sacrificing the finish accuracy.

FIG. 7 shows the robot end-effector holding tool 18 and the forces resulting from processing with active force control. Traditionally, passive force control was used to maintain a constant compliant force between the holding tool 18 and the workpiece 20. The robot end-effector holding tool 18 of the present embodiment allows the robot 14 to react to the current or present state in real time, which allows the system 10 to avoid or prevent overcutting or undercutting and to achieve the desired final finished profile. In the robot end-effector holding tool 18, the blending environment is modeled as a mass-spring-damper system. The force sensor 50 is mechanically attached to the end-effector holding tool 18 modeled as a spring-damper model, where kₛ and cₛ are the stiffness and the damping coefficients of the sensor, respectively. The parameter me is the mass of the robotic end-effector holding tool 18, kₑ and cₑ are the stiffness and damping coefficients of the contact environment, respectively, and fₛ and fₙ are the sensing force and vertical contact force, respectively.

FIG. 8 shows a finishing device 30 for blending the workpiece 20, with a decoupling mechanism control system. The finishing device 30 includes the finishing tool 36, in this embodiment the finishing tool 36 has a blending wheel 90 mounted at the end of a bent arm 92, which pivots about a pivot point 94. The other end of the bent arm 92 is held by a pre-loaded spring 96, such that a force F on the blending wheel 90 is opposed by a force J from the pre-loaded spring 96. A closed loop long abrasive belt 98 runs around a drive wheel 102 and several passive wheels including the blending wheel 90, a tension wheel 104, and three idler wheels 106. The abrasive belt 98 runs around the outer surface of the blending wheel 90 and is abrades the turbine blade surface. Therefore the thickness of the belt 98 is taken into account when determining the position of the workpiece 20, relative to that of the blending wheel 90.

The decoupling mechanism control system includes the displacement probe 56 (which measures the displacement of the bent arm 92), the force gauge 52 mechanically attached to the bent arm 92, the pre-loaded spring 96, and the servo-driven cam system with the cam 62 and the motor 60 or other actuator. The force gauge 52 may be a strain gauge type of force sensor, which measures the strain in the bent arm 92. An additional element used to control the decoupling mechanism control system is the force sensor 50 on the robot end-effector holding tool 18. The decoupling mechanism moves the head of the finishing tool 36, that is the blending wheel 90, precisely to touch the workpiece 20 and keep different contact (polishing or thrust) forces to remove welded excess metal during the overhauling process. The contact force and feedback system are real-time controlled by the computer 12 based on a controlled material removal rate strategy.

During use the blending wheel 90 tends to “sink” when the contact force is high, but “float” in the case of a lower contact force. During blending, the laser sensor 54 detects, in-situ, the turbine blade tip height H at the current blending point and the computer 12 determines the respective required contact force in accordance with its blending process knowledge database 42.

Both the force moment sensor 50, at the robot end-effector holding tool 18, and the force gauge 52, in the finishing device 30, provide force feedback information, generally simultaneously, on the actual value of the contact force exerted between the workpiece 20 and the blending wheel 90. After calculating the difference between the desired value of the contact force, the computer 12 controls the digital servo motor 60 to drive the cam 62 to extend or contract the pre-loaded spring 102 so as to maintain the desired contact force at the current blending point between the workpiece 20 and the blending wheel 90. Positional information of the blending wheel 90 provided by displacement probe 56 and by the servo motor encoder 58, are used by the treating system 10 to maintain the blending wheel 90 at a desired position for the current blending point. The resolution analysis and accuracy of motion resolution for the encoder 58 may be represented, for example, by [10 mm/(encoder resolution)*(harmonic gear ratio)]*Dt/Df, where Dt is the distance from the arm pivot point 94 to the center of the blending wheel 90 and Df is the distance from the arm pivot point 94 to the point of action of the spring 96 and the arm 92. Thus for Dt=150 mm, Df=87 mm, encoder resolution=1000 and harmonic gear ratio=50, the accuracy of motion resolution=0.000345 mm (=345 μm [microns]).

The desired contact force is primarily maintained by the servo-controlled cam mechanism 62, 60 while the robot 14, under the control of the computer 12 via the robot instructor 26, focuses on following the desired blending path. When the contact force increases or decreases, before the cam 62 is rotated to provide an appropriate response, the spring 96 automatically generates a bigger or smaller force, respectively, to oppose the contact force, through corresponding contraction or expansion, as the bent arm 92 moves. With this active compliant approach, better mechanical advantage for force control is achieved, resulting in greater dexterity with a faster response, since the cam mechanism 62 is directly linked to the motor 60 instead of to other types of mechanical linkage.

The cam mechanism 62, instead of controlling robot 14, may drive the system for the fine grinding. The industrial robot 14 may act as the rough positioner (for example a “left hand”, following the predefined profile path) and the grinding/cam mechanism may act as the fine positioner (for example a “right hand”, controlled by the force gauge 52 and the laser sensor 54). The laser sensor 54 acts as an “eye” to monitor the difference between the added materials and the parent materials.

With respect to the global frame, the blending wheel is kept to a relative static location, which enables the laser sensor 54 to perform better measurements, as the deviation in the distance between the turbine blade 20 and the laser sensor 54 remains in a relatively narrow range. Additionally, the spring 96 acts as a compliant device; when the contact force exceeds the desired value by a large amount, the spring 96 provides a certain range of compliance to avoid causing damage to the robot 14, the workpiece 20, or the blending machine 30. When an abnormally large increase in the contact force, beyond a specified limit, is detected by the computer 12, the computer 12 issues a command to the robot 14, via the robot instructor 26, to stop operation. The spring compliance and the computer monitoring process, together with other safety measures such as a laser curtain, helps to ensure that the treating system 10 is operating under safe conditions.

In this embodiment the finishing tool 36 is a blending wheel 90, with an abrasive belt 98 around it. In other embodiments, other treatment tools are provided, such as a grinding or sanding wheel, which contacts the workpiece directly, rather than through a belt. Such a grinding or sanding wheel may be driven by a belt, as in the illustrated embodiment.

When the Z-axis displacement in FIG. 8 is less than a critical displacement Z_{c}, the pre-loaded spring 96 does not contract any further, and the tool head 90 acts as a fixed tool head. Beyond the critical Z-axis displacement, the Z-axis movement causes the blending wheel to “sink”. Given the geometry of the workpiece 20, a desirable force level can be achieved by associating the turbine blade tip height with the respective blending point. Once blending conditions, including pre-load, spring stiffness, blending wheel hardness and construction are known, the desirable force level can be determined. Sensitivity of the contact force to brazed layer variation can be adjusted to the required level by changing the spring stiffness and the pre-load of the pre-loaded spring 96. Such a control scheme works well to compensate for both global variations mainly due to part distortions and local variations such as variable braze thickness and transitional lines from non-brazing area to brazing area. The process knowledge is encapsulated so that optimum process parameters can be inferred according to individual part conditions.

It will be appreciated that while only a few specific embodiments of the invention have been described herein for the purposes of illustration, various changes or modifications may be made without departing from the scope and spirit of the invention.

1. A system for treating a workpiece, comprising:
a robot having a holder for holding the workpiece and traversing the workpiece along a predetermined path;
a treatment device for performing a treatment on the workpiece, the treatment device having a treatment tool for contacting the workpiece at at least one point along the path;
a contact force measurement device for providing information on the actual contact force between the treatment tool and the workpiece;
a position measurement device for providing information on the actual position of the treatment tool; and
a controller in communication with the robot and the treatment device for controlling the system in accordance with predetermined position data and predetermined contact force data, based on the predetermined path of the workpiece, the controller being responsive to the actual contact force information and the actual position information, the controller receiving the actual contact force information from the contact force measurement device and the actual position information from the position measurement device.

2. A system of claim 1, further comprising a robot instructor in communication with the robot for instructing the robot along the predetermined path, under the control of the controller.

3. A system of claim 1, wherein the controller uses the predetermined position data to control the robot.

4. A system of claim 1, wherein the controller uses the predetermined contact force data to control the treatment device.

5. A system of claim 1, wherein the controller is a computer.

6. A system of claim 1, wherein the treatment tool comprises a blending wheel.

7. A system of claim 1, wherein the contact force measurement device is mechanically attached to at least one of the holder and the treatment device.

8. A system of claim 1, wherein the contact force measurement device comprises at least one of a force sensor attached to the robot, and a force gauge attached to the treatment device.

9. A system of claim 1, wherein the position measurement device is mechanically attached to the treatment device.

10. A system of claim 1, wherein the position measurement device comprises at least one of a force gauge and a displacement sensor.

11. A system of claim 1, wherein the workpiece comprises a turbine blade.

12. A system of claim 1, further comprising a decoupling mechanism in communication with the controller and mechanically attached to the treatment device for adjusting the position of the treatment device and the contact force between the treatment tool and the workpiece.

13. A system of claim 12, wherein the decoupling mechanism comprises an actuator and a cam.

14. A system of claim 1, further comprising a database for storing the predetermined data.

15. A system of claim 1, further comprising an optical sensor for scanning the surface of the workpiece and providing profile data of the workpiece for determining the predetermined path.

16. A system of claim 15, wherein the optical sensor comprises a laser emitting sensor with a controllable laser beam incidence direction, to be substantially normal to the surface of the workpiece at a scanning point of the workpiece surface.

17. A system of claim 1, wherein the treatment device is a finishing device and the treatment tool is a finishing tool.

18. A system of claim 1, for surface finishing a workpiece.

19. A method of treating a workpiece, comprising:
holding and traversing the workpiece along a predetermined path;
performing a treatment on the workpiece by way of a treatment tool at at least one point along the path;
determining the actual contact force between the treatment tool and the workpiece;
determining the actual position of the treatment tool; and
controlling the system in accordance with predetermined position data and predetermined contact force data, based on the predetermined path of the workpiece, in response to the determined actual contact force and the determined actual position information.

20. A workpiece which has been treated according to a method comprising:
holding and traversing the workpiece along a predetermined path;
performing a treatment on the workpiece by way of a treatment tool at at least one point along the path;
determining the actual contact force between the treatment tool and the workpiece;
determining the actual position of the treatment tool; and
controlling the system in accordance with predetermined position data and predetermined contact force data, based on the predetermined path of the workpiece, in response to the determined actual contact force and the determined actual position information.
